(19) United States
(12) Patent Application Publication
(10) Pub. No.: US 2017/0292402 A1
(43) Pub. Date: Oct. 12, 2017

(54) ORGANIC MATRIX COMPOSITE THERMAL BARRIER COATING

(71) Applicant: United Technologies Corporation, Farmington, CT (US)

(72) Inventors: Alan C. Barron, Jupiter, FL (US); James Masloski, Lake Worth, FL (US); John D. Riehl, Hebron, CT (US)

(21) Appl. No.: 15/095,235

(22) Filed: Apr. 11, 2016

(51) Int. Cl. F01D 25/00; B05D 7/00; F01D 25/24

(52) U.S. Cl. CPC F01D 25/005; F01D 25/24; B05D 7/50

(57) ABSTRACT

A modified organic matrix composite having a thermal barrier coating comprising a substrate comprising an organic matrix composite; a roughness layer coupled to the substrate; a bonding layer coupled to the roughness layer opposite the substrate; and a thermal barrier coating coupled to the bonding layer opposite the roughness layer.

### BACKGROUND

The present disclosure is directed to a modified organic matrix composite having a thermal barrier coating.

Organic matrix composites (OMCs) are used in the aerospace industry for the weight reductions they offer when used to replace metal components. However, exposure to high temperature environments promotes oxidative degradation which effectively leads to reduced mechanical mechanical properties. Thus, even currently known high temperature OMCs utilizing high temperature matrix materials have limited application.

One solution to protecting the OMC structures from the high temperature environments is to apply advanced ceramic thermal barrier coatings.

Thermal protection systems in the form of thermal barrier coatings (TBCs) have been used with metals for many years. In such cases, low thermal conductivity materials are coated on the surface of the part to create a thermal gradient between the high temperature environment and the part such that the subsurface material is not exposed to a temperature above its maximum use temperature. However, OMCs present surface features and material attributes that are separate and unique from metallic substrates.

In applications involving aerospace turbine engine components, plasma sprayed thermal barrier coatings do not readily adhere well to a typical carbon fiber based organic matrix composite (OMC). As a result, surface features of the OMC require modification in order to improve adhesion. Proper surface preparation is widely recognized as critical to long term bond performance and commonly embodies the application of a mechanical process such as grit blasting or hand abrasion to remove surface contaminants and to roughen the surface to increase the effective area of the attachment. Poorly controlled abrasion risks exposure of the bare carbon fiber which, due to its relative non-polar nature, would negatively impact bondability. Excessive abrasion risks further damage of the carbon reinforcement leading to degraded and compromised capability. More recently, alternative surface preparation work has been performed utilizing nonconventional techniques such as laser or plasma treatment which target the functionalization of the composite surface so as to increase surface energy and improve interactions between material interfaces. While surface modification might be desirable and even necessary, it undoubtedly will add cost and complexity. Furthermore, the degree of surface roughening must be properly controlled to preclude underlying fiber damage. The end result of limited surface modification is poor coating adhesion that ultimately restricts the use of ceramic thermal barrier coatings on OMC aerospace turbine engine components.

### SUMMARY

In accordance with the present disclosure, there is provided a modified organic matrix composite having a thermal barrier coating comprising a substrate comprising an organic matrix composite; a roughness layer coupled to the substrate; a bonding layer coupled to the roughness layer opposite the substrate; and a thermal barrier coating coupled to the bonding layer opposite the roughness layer.

In another and alternative embodiment, the roughness layer comprises a single sheet of silica based glass fabric.

In another and alternative embodiment, the substrate comprises layered sheets of carbon fiber suspended within organic matrix solid.

In another and alternative embodiment, the roughness layer comprises a surface roughness.

In another and alternative embodiment, the bonding layer comprises 80 percent aluminum and 20 percent silicon.

In another and alternative embodiment, the roughness layer includes exposed silica fibers.

In another and alternative embodiment, the roughness layer is selected from the group consisting of astro-quartz and Nextel.

In accordance with the present disclosure, there is provided a turbine engine component comprising a casing, the casing including a substrate, the substrate comprising an organic matrix composite; a roughness layer coupled to the substrate; a bonding layer coupled to the roughness layer opposite the substrate; and a thermal barrier coating coupled to the bonding layer opposite the roughness layer.

In another and alternative embodiment, the roughness layer comprises a single sheet of silica based glass fabric.

In another and alternative embodiment, the roughness layer comprises a surface roughness.

In another and alternative embodiment, the substrate comprises layered sheets of carbon fiber suspended within organic matrix solid.

In another and alternative embodiment, the bonding layer comprises 80 percent aluminum and 20 percent silicon.

In another and alternative embodiment, the roughness layer includes exposed silica fibers.

In accordance with the present disclosure, there is provided a process for manufacturing a turbine engine component, the process comprising the steps of providing a substrate, the substrate comprising an organic matrix composite; applying a roughness layer to the substrate; coating the roughness layer with a bonding layer; and coating the roughness layer with a thermal barrier coating.

In another and alternative embodiment, the process further comprises roughening the roughness layer.

In another and alternative embodiment, the roughen step comprises exposing a silica based material fibers.

In another and alternative embodiment, the roughness layer comprises a single sheet of silica based glass fabric.

In another and alternative embodiment, the substrate comprises layered sheets of carbon fiber suspended within organic matrix solid.

In another and alternative embodiment, the bonding layer comprises 80 percent aluminum and 20 percent silicon.

Other details of the modified organic matrix composite having a thermal barrier coating are set forth in the following detailed description and the accompanying drawing wherein like reference numerals depict like elements.

### BRIEF DESCRIPTION OF THE DRAWINGS

FIG. 1 is a schematic representation of a modified organic matrix composite with thermal barrier coating.

### DETAILED DESCRIPTION

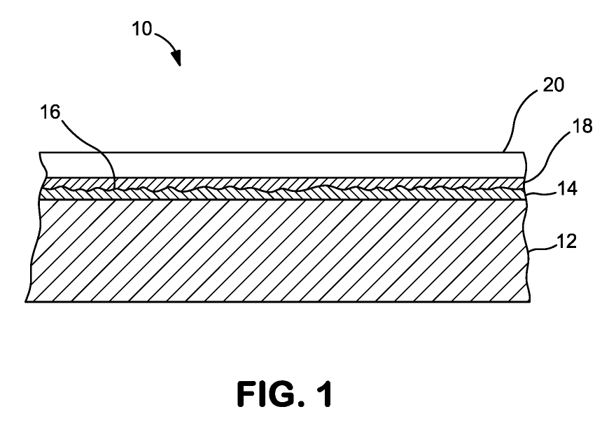

Referring to the drawing, FIG. 1 shows a component 10 for particular use in high temperature environments such as a gas turbine engine, although other applications are contemplated within the scope of the disclosure. Component 10 includes a substrate 12 having a roughness sheet or layer 14. A surface 16 of the roughness layer 14 is opposite the substrate 12. A bonding layer 18 can be applied to the surface 16 of the roughness layer 14. A thermal barrier coating (TBC) 20 can be coupled to the bonding layer 18 opposite the roughness layer 14. The thermal barrier coating 20 can be exposed to temperatures of up to about 725° F. (385° C.).

The substrate 12 can be formed from organic matrix composite materials. Organic matrix composite structures are constructed from layered sheets of carbon fiber suspended within an organic matrix solid. In an exemplary embodiment, the OMC matrix material is a high temperature polyimide system. It is contemplated that in alternative embodiments the substrate 12 can include lower temperature resin systems such as bismaleimide-based polyimide systems (BMI) (e.g., Cycom® 5250-4).

The roughness layer 14 can comprise a single sheet of Nextel, astro-quartz or other silica based glass fabric as the outer most, last composite layer of the OMC. The roughness layer 14 enables very aggressive surface roughening, that otherwise would not be performed on the OMC, due to the negative impact of surface modification to the OMC. The roughness layer 14 protects the substrate 12 OMC materials. The roughness layer 14 prevents the negative adhesive capability impact on the OMC substrate materials as well. It is desirable to expose the fibers of the roughness layer 14, in order to enhance coating adhesion and durability. The roughness layer 14 is configured to receive surface feature modification in order to improve adhesion.

The thermal barrier coating 20 can be selected to optimize the bond and match the coefficient of thermal expansion (CTE) of the substrate 12. It is also desirable to choose coating materials, 18, 20 that are a good match to the silica based fabric with respect to adhesion and durability. The bonding layer 18 can comprise 80 percent aluminum and 20 percent silicon.

By including the last sheet of silica based fabric, any aggressive surface roughening that exposes the silica based fibers, results in a beneficial adhesion benefit over and above that obtained by just roughening alone. It is also desirable to expose the fiber of the roughness layer 14 to enhance coating adhesion and durability.

The choice of 80% aluminum/20% silicon as a bonding layer material, coupled with the silica based fabric layer has resulted in excellent adhesion and durability as shown by long duration, high temperature cyclic exposure test results.

There has been provided a modified organic matrix composite having a thermal barrier coating. While the modified organic matrix composite having a thermal barrier coating has been described in the context of specific embodiments thereof, other unforeseen alternatives, modifications, and variations may become apparent to those skilled in the art having read the foregoing description. Accordingly, it is intended to embrace those alternatives, modifications, and variations which fall within the broad scope of the appended claims.

What is claimed is:

1. A modified organic matrix composite having a thermal barrier coating comprising:
a substrate comprising an organic matrix composite;
a roughness layer coupled to said substrate;
a bonding layer coupled to said roughness layer opposite said substrate; and
a thermal barrier coating coupled to said bonding layer opposite said roughness layer.

2. The modified organic matrix composite according to claim 1, wherein said roughness layer comprises a single sheet of silica based glass fabric.

3. The modified organic matrix composite according to claim 2, wherein said substrate comprises layered sheets of carbon fiber suspended within organic matrix solid.

4. The modified organic matrix composite according to claim 2, wherein said roughness layer comprises a surface roughness.

5. The modified organic matrix composite according to claim 1, wherein said bonding layer comprises 80 percent aluminum and 20 percent silicon.

6. The modified organic matrix composite according to claim 1, wherein said roughness layer includes exposed silica fibers.

7. The modified organic matrix composite according to claim 1, wherein said roughness layer is selected from the group consisting of astro-quartz and Nextel.

8. A turbine engine component comprising:
a casing, said casing including a substrate, said substrate comprising an organic matrix composite;
a roughness layer coupled to said substrate;
a bonding layer coupled to said roughness layer opposite said substrate; and
a thermal barrier coating coupled to said bonding layer opposite said roughness layer.

9. The turbine engine component according to claim 8, wherein said roughness layer comprises a single sheet of silica based glass fabric.

10. The turbine engine component according to claim 8, wherein said roughness layer comprises a surface roughness.

11. The turbine engine component according to claim 8, wherein said substrate comprises layered sheets of carbon fiber suspended within organic matrix solid.

12. The turbine engine system according to claim 8, wherein said bonding layer comprises 80 percent aluminum and 20 percent silicon.

13. The turbine engine system according to claim 8, wherein said roughness layer includes exposed silica fibers.

14. A process for manufacturing a turbine engine component, said process comprising the steps of:
providing a substrate, said substrate comprising an organic matrix composite;
applying a roughness layer to said substrate;
coating said roughness layer with a bonding layer; and
coating said roughness layer with a thermal barrier coating.

15. The process of claim 14, further comprising:
roughening said roughness layer.

16. The process of claim 14, wherein said roughen step comprises exposing a silica based material fibers.

17. The process of claim 14, wherein said roughness layer comprises a single sheet of silica based glass fabric.

18. The process of claim 14, wherein said substrate comprises layered sheets of carbon fiber suspended within organic matrix solid.

19. The process of claim 14, wherein said bonding layer comprises 80 percent aluminum and 20 percent silicon.
